(19) United States
(12) Patent Application Publication
(10) Pub. No.: US 2026/0316970 A1
(43) Pub. Date: Oct. 15, 2026

(54) Camera Gimbal Adapter For Unmanned Aerial Vehicle

(71) Applicant: Dronebase, Inc., Los Angeles, CA (US)

(72) Inventors: Philip D. Jahns, Austin, TX (US); Jenner B. Lochridge, Austin, TX (US)

(21) Appl. No.: 19/645,873

(22) Filed: Apr. 13, 2026

Related U.S. Application Data
(60) Provisional application No. 63/787,479, filed on Apr. 11, 2025.

(51) Int. Cl. B64U 20/87; B64U 101/30; F16F 15/04; G03B 15/00; G03B 17/56

(52) U.S. Cl. CPC B64U 20/87; F16F 15/04; G03B 15/006; G03B 17/561; B64U 2101/30

(57) ABSTRACT

An attachment for an unmanned aerial vehicle (UAV) includes a support structure configured to couple to a mounting surface of the UAV. A gimbal is coupled to the support structure. A camera is supported by the gimbal. The camera can have a sensor, the sensor having a capture line of sight normal to a plane of the sensor. The support structure and the gimbal are configured to support the camera relative to the UAV so that the capture line of sight of the sensor of the camera is uninterrupted when pivoted upwardly relative to a horizontal plane by at least 60 degrees and downwardly relative to the horizontal plane by at least 60 degrees.

### CROSS-REFERENCE TO RELATED APPLICATIONS

The application claims priority to, and the benefit of the filing date of, U.S. Provisional Patent Application No. 63/787,479, filed Apr. 11, 2025, the entirety of which is hereby incorporated by reference herein.

### FIELD

The application is generally related to unmanned aerial vehicles (UAVs) and, in particular, to gimbal adapters for UAVs and UAVs comprising such gimbal adapters.

### BACKGROUND

UAVs are used in various industries from recreation to surveying to inspection. In certain applications, such as inspection of wind turbines, it can be advantageous to capture images both from an upward angle and a downward angle. However, given the nature of UAVs, the cameras commonly attach to an underside of the UAV and are unable to pivot to capture images upwardly above a certain angle (e.g., 40 degrees). This angle is limited by the body and propellers of the UAV being in the line of sight of the camera. Although certain UAVs can be reconfigured to instead attach the camera to face upwardly, a process of capturing images from both an upward angle and a downward angle requires an added step of landing the UAV and reconfiguring the UAV, which is not only time consuming, but can require realignment or recalibration.

Accordingly, a need exists for a UAV that can capture images in an upward direction and a downward direction during a single flight.

### SUMMARY

Disclosed herein, in various aspects, is an attachment for an unmanned aerial vehicle (UAV). The attachment comprises a support structure configured to couple to a mounting surface of the UAV. A gimbal is coupled to the support structure. A camera is supported by the gimbal. The camera can have a sensor, the sensor having a capture line of sight. The support structure and the gimbal are configured to support the camera relative to the UAV so that the capture line of sight of the sensor of the camera is uninterrupted when pivoted upwardly relative to a horizontal plane by at least 60 degrees and downwardly relative to the horizontal plane by at least 60 degrees.

In another aspect, an attachment for an unmanned aerial vehicle includes a support structure configured to couple to a mounting surface of the UAV. The support structure comprises at least one mounting bracket that is configured to couple to the mounting surface of the UAV and a support bracket. At least one damping element extends between the at least one mounting bracket and the support bracket. A gimbal is coupled to the support structure. The gimbal has a camera mount. The attachment supports the camera mount at a position that is forwardly spaced at least 0.1 inches from a forward-most mounting bracket of the at least one mounting bracket.

Also disclosed herein are assemblies comprising UAVs with said attachments coupled thereto. Also disclosed herein are methods of coupling such attachments to UAVs.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a perspective view of an exemplary attachment as disclosed herein.

FIG. 2 is a perspective view of a support structure of the attachment of FIG. 1.

FIG. 3 is a lower partial perspective view of an assembly comprising a UAV and an attachment as disclosed herein.

FIG. 4 is a lower perspective view of an assembly comprising a UAV and an attachment as disclosed herein.

FIG. 5 is a block diagram of computing system for use with the attachment of FIG. 1.

FIG. 6 is a schematic diagram illustrating a capture line of sight of a camera of the attachment.

FIG. 7 shows a schematic diagram illustrating a capture line of sight of a camera supported by a conventional gimbal.

FIG. 8 is an underside perspective view of the UAV of FIG. 3 having rear mounting brackets and a rear suspension portion of a support bracket coupled thereto.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used throughout, the singular forms “a,” “an,” and “the” include plural referents unless the context clearly dictates otherwise. Thus, for example, unless the context dictates otherwise, reference to “a damping element” provides disclosure of embodiments in which only a single such damping element is provided, as well as embodiments in which a plurality of such damping elements are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedents “about,” “substantially,” or “generally,” it is contemplated that values within up to 15%, up to 10%, up to 5%, or up to 1% (above or below) of the particularly stated value can be included within the scope of those aspects. In other aspects, when angular values are approximated by use of the antecedents “about,” “substantially,” or “generally,” it is contemplated that angular values within up to 15 degrees, up to 10 degrees, up to 5 degrees, or up to one degree (above or below) of the particularly stated angular value can be included within the scope of those aspects.

In the following description and claims, wherever the word “comprise” or “include” is used, it is understood that the words “comprise” and “include” can optionally be replaced with the words “consists essentially of” or “consists of” to form another embodiment.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

Disclosed herein is an assembly for attaching to a UAV to capture target information (e.g. images, range finding identification or any directional based sensor capture) in a controllably upward direction and a controllably downward direction (preferably, during a single uninterrupted flight). Generally, the UAV can be or comprise a motion device maneuverable in space in three-dimensional space (e.g., relative to three perpendicular axes) for carrying a payload. For example, the motion device can comprise a body and one or more propellers (e.g., 4 or 6 propellers) configured to effect motion of the body. The one or more propellers can be driven by respective motors (e.g., battery-powered electric motors). In some aspects, the motion device can be configured such that the payload carried thereby has a certain aspect of the payload's function obstructed or impacted by the configuration of the motion device. For example, the payload can be or can include a camera having field of view. Often, the motion device (e.g., the body and/or the propeller) can block at least a portion of the field of view of the camera. When the field of view is substantially blocked (e.g., blocking a center of the field of view), function of the camera can be inhibited. Likewise, the payload can be or can comprise other sensors, including thermal sensors, radio frequency sensors, radar, laser sensors (e.g., range sensors), etc., and the motion device can obstruct the capture of such sensors. In further aspects, additional payload devices, including mechanical arms and the like can be obstructed by the motion device. Embodiments disclosed herein can reduce or minimize the obstruction or impact to such sensors or other payload devices.

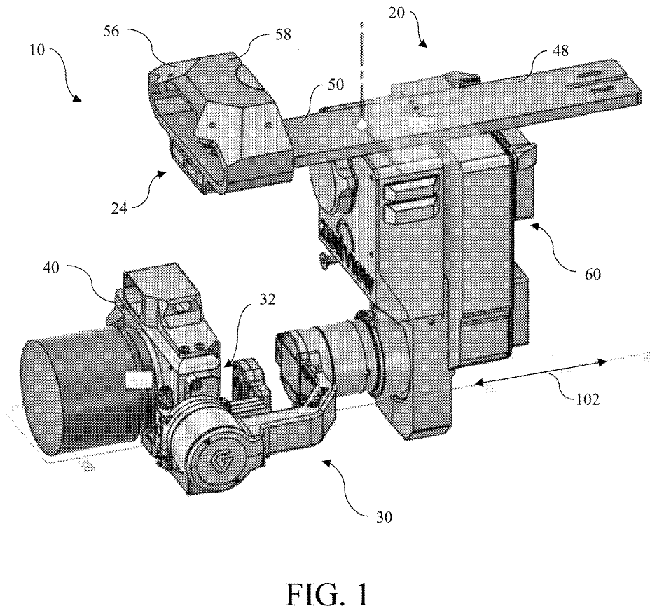

Referring now to FIGS. 1-3 and 5, an attachment 10 for an unmanned aerial vehicle 100 (UAV) is shown. The attachment 10 can comprise a support structure 20 configured to couple to a mounting surface 110 of the UAV 100. A gimbal 30 can be coupled to the support structure 20. A camera 40 can be supported by the gimbal 30. The camera 40 can have a sensor 42 arranged on a plane. For example, the sensor 42 can have a planar sensing surface coplanar with said plane. The sensor 42 can have a capture line of sight 12. The support structure 20 and the gimbal 30 can be configured to support the camera 40 relative to the UAV 100 so that the capture line of sight 12 of the sensor 42 of the camera is uninterrupted when pivoted upwardly relative to a horizontal plane 108 by at least 60 degrees, at least 70 degrees, at least 80 degrees, at least 89 degrees, and downwardly relative to the horizontal plane by at least 60 degrees, at least 70 degrees, at least 80 degrees, at least 89 degrees, or at least 90 degrees.

In further aspects, the support structure 20 and the gimbal 30 can be configured to support the camera 40 relative to the UAV so that the sensor of the camera has an uninterrupted capture line of sight when pivoted upwardly relative to a horizontal plane by at least 80 degrees (e.g., up to 89 degrees or up to 90 degrees) and downwardly relative to the horizontal plane 108 by at least 80 degrees. In still further aspects, the support structure 20 and the gimbal 30 can be configured to support the camera 40 relative to the UAV so that the sensor of the camera has an uninterrupted sensor capture line of sight when pivoted positively or negatively vertical relative to the horizontal or UAV level plane 108 by at least 80 degrees upwardly (positively) and downwardly (negatively) relative to the horizontal plane by at least 89 degrees. That is, the horizontal plane can be perpendicular to a direction of gravity. Further, the line of positive and negative capture line of sight of the sensor of the camera can be measured relative to the horizontal while the UAV 100 is not moving laterally (e.g., hovering in a fixed position). Accordingly, the sensor of the camera 40 can have an uninterrupted capture line of sight as disclosed herein relative to a horizontal plane while the UAV is not moving laterally. That is, the orientation of the UAV can change relative to the horizontal plane as the UAV moves through three-dimensional space. The capture line of sight can be uninterrupted when the UAV is oriented in a position in which the UAV is not moving.

As used herein, the term “capture line of sight” can be measured normal to a plane of the sensor. For example, the term “capture line of sight” can correspond to a center of a sensor's capture. Accordingly, an “uninterrupted capture line of sight” or a “capture line of sight” that is “uninterrupted” can refer to a center of a sensor's capture (e.g. an image captured by the camera) being free of the UAV (e.g., a body or a propeller of the UAV). Thus, the sensor's capture (e.g., the image captured by the camera) does not include capture of any portion of the UAV within the center of the sensor's capture. In some aspects, the capture line of sight can extend perpendicular to an aperture of the camera.

In some aspects, the gimbal 30 can be configured to permit rotation about at least pitch and roll axes. In further aspects, the gimbal 40 can be configured to fix a yaw of the camera (e.g., relative to the UAV). In further aspects, the gimbal 40 can be configured to fix a rotation of the camera. That is, pitch and roll of the camera 40 can be maintained generally constant (e.g., within 10 degrees of a starting rotational position about the pitch axis and within 10 degrees of a starting position about the roll axis) as the UAV moves, while the camera 30 can move with the UAV 100 about a vertical axis. Accordingly, in some aspects, the gimbal 40 can be a 2-axis gimbal.

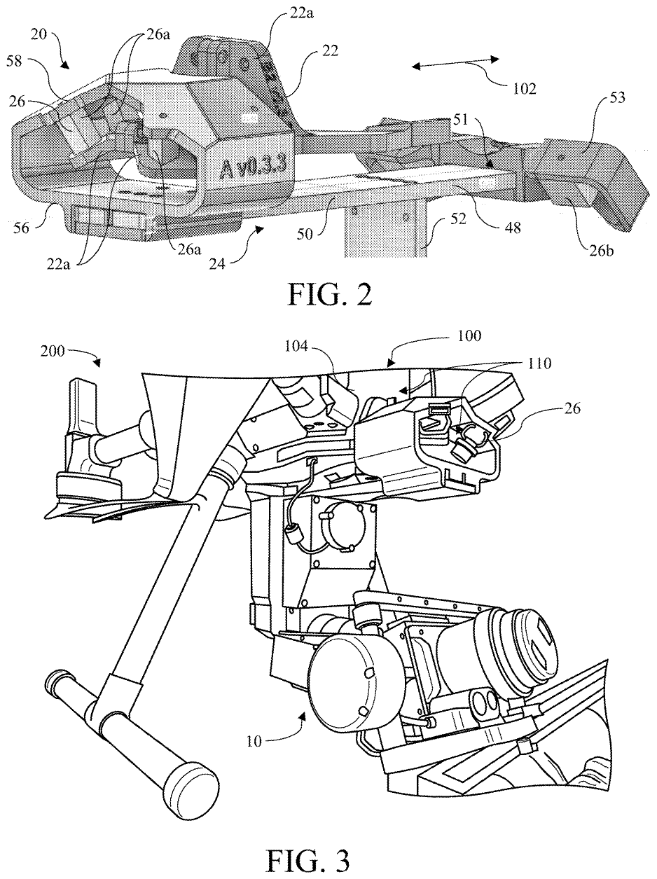

Referring to FIGS. 2-3, the support structure 20 can comprise at least one mounting bracket 22 that is configured to couple to the mounting surface 110 of the UAV 100. The support structure 20 can further comprise a support bracket 24. At least one damping element 26 can extend between the at least one mounting bracket 22 and the support bracket 24. In this way, each damping element 26 can permit damped movement between the at least one mounting bracket 22 and the support bracket 24. That is, the damping elements can retard relative movement between the at least one mounting bracket 22 and the support bracket 24. In some aspects, the at least one mounting bracket 22 can comprise a plurality of mounting brackets, and the at least one damping element 26 can comprise a plurality of damping elements. Each mounting bracket 22 of the plurality of mounting brackets can be supported by at least one respective damping element 26 of the plurality of damping elements.

In some optional aspects, the plurality of damping elements 26 can comprise four front damping elements 26a and a pair of rear damping elements 26b that are spaced from the forward damping elements along a longitudinal axis 102. For example, the four front damping elements 26a can comprise two pairs of damping elements that are longitudinally spaced from each other. A first mounting bracket of the at least one mounting bracket 22 can be supported relative to the support bracket entirely by one or more of the four front damping elements 26a. In this way, the gimbal 40 can be supported via dampers to inhibit movement between the mounting structure 20 and the UAV. The pair of rear damping elements 26b can be transversely spaced (e.g., perpendicular to the longitudinal axis 102).

In some aspects, the at least one damping element 26 can comprise a wire rope (FIGS. 3 and 8). In various additional aspects, the at least one damping element 26 can comprise other suitable structure, such as an elastic pad or a piston. In some aspects, when a plurality of damping elements 26 are provided, it is contemplated that at least a first damping element of the plurality of damping elements can be a different type of damping element than at least a second damping element of the plurality of damping elements. In other aspects, the plurality of damping elements can all be of the same type.

In some optional aspects, the support bracket 24 can comprise a T-shaped bracket 48 having a horizontal portion 50 and a vertical portion 52 extending downwardly from the horizontal portion. The support bracket 24 can further comprise a front structure 56 coupled to the horizontal portion 50 forwardly of the vertical portion 52 along the longitudinal axis 102. The front structure 56 can extend upwardly from the horizontal portion 50 and can comprise a top portion 58 from which a first portion of the plurality of damping elements 26 attach and extend downwardly therefrom. For example, the front structure can comprise a loop within which one or more mounting brackets 22 are received and supported by damping elements 26. In some aspects, the at least one mounting bracket 22 can comprise at least one forward mounting bracket 22a. For example, optionally, in these aspects, the at least one mounting bracket 22 can comprise a pair of forward mounting brackets 22a. Each forward mounting bracket 22a of the pair of forward mounting brackets can be supported by at least two damping elements 26 of the plurality of damping elements.

Referring also to FIG. 8, the at least one mounting bracket 22 can comprise a pair of rear mounting brackets 22b. Each rear mounting bracket 22b of the pair of rear mounting brackets can be secured to the support bracket 24 by a respective rear damping element 26b. For example, the horizontal portion 50 of the T-shaped bracket can be received within a slot 51 of a rear suspension portion 53 of the support bracket 24. Each rear damping element 26b can extend between the rear suspension portion 53 and a respective rear mounting bracket 22b. In some aspects, an entirety of the support bracket 24 can be isolated by the at least one mounting bracket 22 by the one or more damping elements 26.

In some aspects, the attachment 10 can support the camera 40 at a position that is within 2 inches of a forward-most mounting bracket (e.g., the at least one forward mounting bracket 22a) of the at least one mounting bracket along the longitudinal axis 102. In further aspects, the attachment 10 can support the camera 40 at a position that is forwardly spaced at least 0.1 inches from a forward end of the forward-most mounting bracket(s) 22a along the longitudinal axis 102. In this way, with the camera 40 pivoted so that the capture line of sight of the sensor of the camera is parallel to a vertical axis, the forward-most mounting bracket(s) 22a (e.g., forward edges thereof) can be outside of the capture line of sight. In further aspects, the gimbal 30 can have a camera mount 32 (e.g., vertical tilt portion of the gimbal). The attachment 10 can support the camera mount 32 of the gimbal 30 at a position that is within 2 inches of or is forwardly spaced at least 0.1 inches from a forward-most mounting bracket of the at least one mounting bracket along the longitudinal axis 102. In other aspects, the attachment 10 can support the camera mount 32 of the gimbal 30 at a position that is within 2 inches from the forward-most mounting bracket of the at least one mounting bracket. In additional aspects, the camera can have a housing. A forward-most portion of the housing can extend forwardly beyond the forward-most mounting bracket by at least 0.1 inches along the longitudinal axis 102. In some aspects, the camera mount 32 can be at least 0.1 inch, at least 1 inch, or at least 2 inches forward of a front portion of the UAV. In some aspects, the camera mount 32 can be at least at least 2 inches, at least 3 inches, at least 4 inches, or at least 5 inches forward of a center of mass of the attachment 10 along the longitudinal axis 102. In some aspects, the camera mount 32 can be at least at least 2 inches, at least 3 inches, at least 4 inches, or at least 5 inches forward of a geometric center of the attachment 10 along the longitudinal axis 102.

The attachment 10 can comprise a housing 60, a memory 70, and at least one processor 72 operably coupled to the memory. The at least one processor 72 and the memory can be received within the housing. The memory 70 can comprise instructions that, when executed by the at least one processor 72, cause the at least one processor to operate the camera 40. The attachment 10 can further comprise a communications module 74 that is configured to receive or transmit data via wired or wireless communication. For example, the communications module 74 can be in communication with a remote control. In some aspects, the housing 60 can have an air intake for cooling internal components. In further aspects, the housing can house a fan that circulates air therethrough.

The attachment 10 can further comprise a range finder 76 (e.g., a one or two dimensional laser range finder). In some aspects, the range finder 76 can be coupled to the gimbal 30. The range finder can be configured to measure distance to a surface along a path that is parallel or substantially parallel (e.g., within 5 degrees, or 4 degrees, or 3 degrees, or 2 degrees, or 1 degree of parallel) to the line of sight of the camera. The laser range finder 76 can be in communication with the at least one processor. The attachment 10 can, accordingly, be configured to capture image and distance data. In some aspects, the at least one processor 72 can be configured to associate image and distance data. In some aspects, the at least one processor can be in communication with a motor 34 of the gimbal 30 that is configured to tilt a position of the camera. For example, the motor 34 can tilt the camera to aim the capture line of sight vertically upwardly or downwardly. The at least one processor 72 can be configured to control operation of the motor 34, thereby allowing remote adjustment of the capture line of sight without moving the UAV.

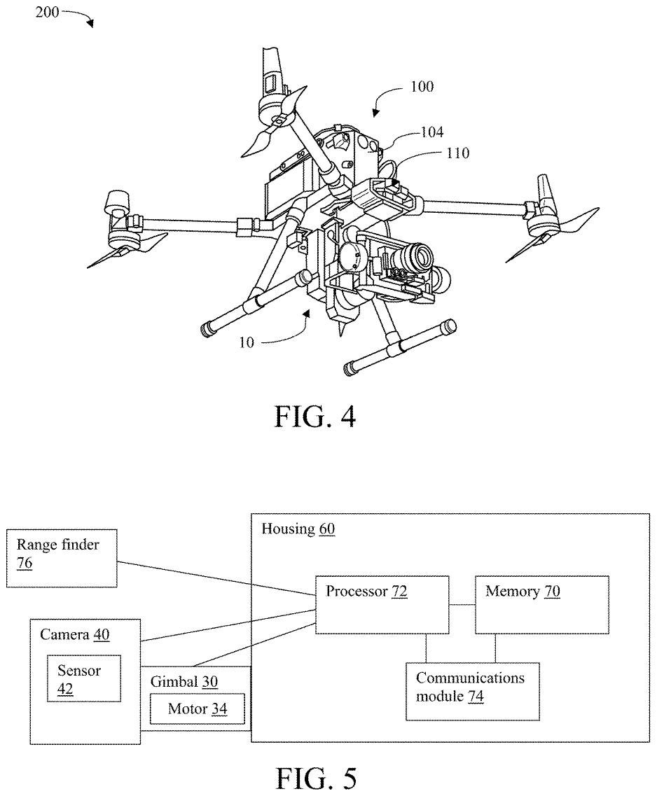

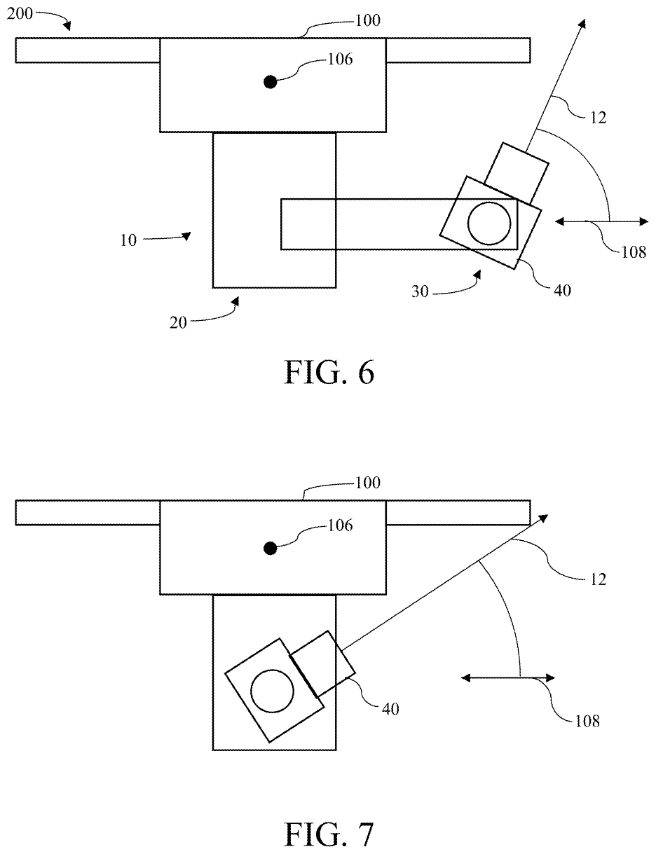

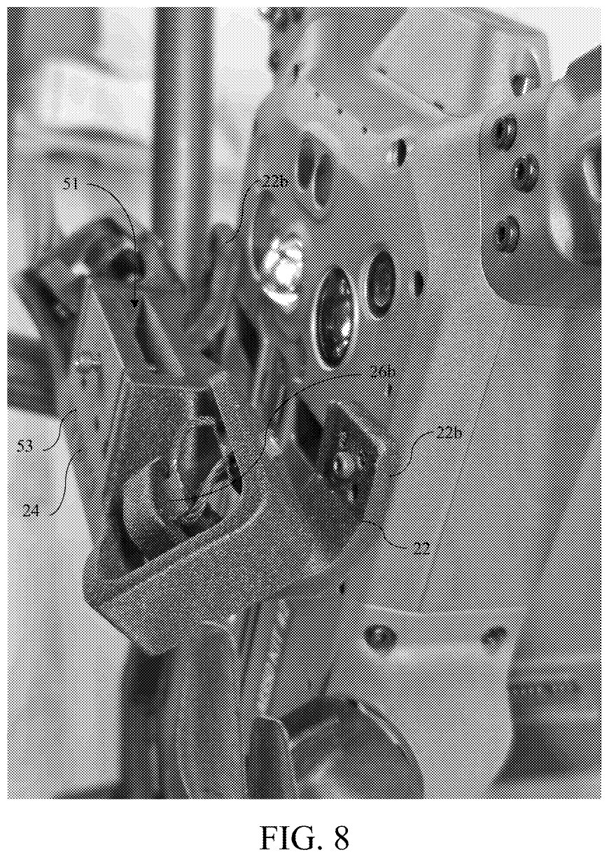

Referring to FIGS. 3-4, an assembly 200 can comprise a UAV 100 and an attachment 10 as disclosed herein. In some aspects, the UAV can be a commercially available drone, such as, for example, a MATRICE 350 drone provided by DJI Enterprise. The UAV 100 can have a body 104 defining a mounting surface 110 (e.g., on a bottom portion of the body). The UAV 100 can have a center of mass 106. The attachment 10 can support the camera at a position that is spaced at least 3 inches, at least 4 inches, at least 5 inches, at least 6 inches, or at least 7 inches from the center of mass of the UAV. In some aspects, the attachment 10 can further be weighted (e.g., by positioning components thereof) to provide a net center of mass of the attachment 10 closer to the center of mass of the UAV (e.g., within 3 inches, or within 2 inches, or within 1 inch) along the longitudinal axis 102.

As noted herein, conventional UAVs are often configured with a camera that captures images in a downward direction. A driving reason for this conventional design is that positioning the camera below the UAV allows the camera to be near the center of mass of the UAV. More particularly, the camera is a relatively heavy payload that, when positioned a substantial distance from the center of mass of the UAV, places an excessive burden on propellers in the horizontal direction of the camera that have to provide additional force to offset the uneven weight distribution relative to the center of mass of the UAV, which can, among other issues, drain the battery and cause difficulty with balancing, control, and even orientation during flight. Accordingly, when designing conventional UAVs, designers are motivated to locate the camera as close to the center of mass of the UAV as possible.

Further, the significant distance of the camera from the center of mass of the UAV can exacerbate vibrations at the camera. Accordingly, the disclosed attachment can include a damping system that mitigates the vibrations, thereby providing high quality imaging.

In some aspects, the support structure 20 can be configured to minimize weight. For example, the T-shaped bracket 48, as well as any other suitable component, can define one or more cutouts that correspond to material removed for reducing weight.

A method of using the UAV 100 can comprise flying the UAV. The method can further comprise operating the camera to take a first image with the camera. The method can further adjusting an angle of the camera and, following adjusting the angle of the camera, taking a second image. One of the first image or the second image can oriented at an angle below horizontal (e.g., downwardly), and the other of the first image or the second image can oriented at an angle above horizontal (e.g., upwardly). Optionally, in these aspects, the other of the first image or the second image can oriented at an angle at least 60 degrees above horizontal or at least 80 degrees above horizontal. A capture line of sight of the sensor of the camera can be unobstructed by the UAV for the first and second images. For example, a center of the first and second images can be free of the UAV. In some aspects, the first and second images can be captured during a single flight so that the UAV does not land between capture of the first and second images.

A method can include removing a first gimbal from a UAV and attaching a second gimbal to the UAV. In this way, a UAV can be retrofitted with an attachment as disclosed herein to provide the advantageous camera positioning disclosed herein. For example, in some optional aspects, the mounting surface 110 (FIG. 3) can be a mounting surface of a conventional UAV to which a conventional gimbal is conventionally attached. Optionally, the second gimbal can be a different type of gimbal than the first gimbal. For example, the first gimbal can be a three-axis gimbal positioned in a downward facing orientation, and the second gimbal can be a two-axis gimbal positioned in a forward orientation using the disclosed attachment, as further described herein.

Although the foregoing invention has been described in some detail by way of illustration and example for purposes of clarity of understanding, certain changes and modifications may be practiced within the scope of the appended claims.

What is claimed is:

1. An attachment for an unmanned aerial vehicle (UAV), the attachment comprising:
a support structure configured to couple to a mounting surface of the UAV;
a gimbal coupled to the support structure; and
a camera supported by the gimbal, the camera having a sensor arranged along a plane, the sensor having a capture line of sight normal to the plane of the sensor;
wherein the support structure and the gimbal are configured to support the camera relative to the UAV so that the capture line of sight of the sensor of the camera is uninterrupted when pivoted upwardly relative to a horizontal plane by at least 60 degrees and downwardly relative to the horizontal plane by at least 60 degrees.

2. The attachment of claim 1, wherein the gimbal is configured to permit rotation about pitch and roll axes.

3. The attachment of claim 2, wherein the gimbal is configured to fix a yaw of the camera.

4. The attachment of claim 1, wherein the support structure and the gimbal are configured to support the camera relative to the UAV so that the capture line of sight of the sensor of the camera is uninterrupted when pivoted upwardly relative to the horizontal plane by at least 80 degrees and downwardly relative to the horizontal plane by at least 80 degrees.

5. The attachment of claim 1, wherein the support structure comprises:
at least one mounting bracket that is configured to couple to the mounting surface of the UAV;
a support bracket; and
at least one damping element extending between the at least one mounting bracket and the support bracket.

6. The attachment of claim 5, wherein the at least one mounting bracket comprises a plurality of mounting brackets, wherein the at least one damping element comprises a plurality of damping elements, wherein each mounting bracket of the plurality of mounting brackets is supported by a respective damping element of the plurality of damping elements.

7. The attachment of claim 6, wherein the plurality of damping elements comprise a pair of rear damping elements and four front damping elements that are spaced from the rear damping elements along a longitudinal axis.

8. The attachment of claim 5, wherein the at least one damping element comprises a wire rope.

9. The attachment of claim 5, wherein the at least one mounting bracket comprises a plurality of mounting brackets, wherein the at least one damping element comprises a plurality of damping elements, wherein the support bracket comprises:
a T-shaped bracket having a horizontal portion and a vertical portion extending downwardly from the horizontal portion;
a front structure coupled to the horizontal portion forwardly of the vertical portion, wherein the front structure extends upwardly from the horizontal portion and comprises a top portion from which a first portion of the plurality of damping elements attach and extend downwardly therefrom.

10. The attachment of claim 9, wherein the at least one mounting bracket comprises a pair of forward mounting brackets, wherein each forward mounting bracket of the pair of forward mounting brackets is supported by at least two damping elements of the plurality of damping elements.

11. The attachment of claim 5, wherein the attachment supports the camera at a position that is forwardly spaced at least 0.1 inches from a forward-most mounting bracket of the at least one mounting bracket.

12. The attachment of claim 1, further comprising:
a housing;
a memory; and
at least one processor operably coupled to the memory, wherein the memory comprises instructions that, when executed by the at least one processor, cause the at least one processor to operate the camera,
wherein the at least one processor and the memory are received within the housing.

13. An attachment for an unmanned aerial vehicle (UAV), the attachment comprising:
a support structure configured to couple to a mounting surface of the UAV, the support structure comprising:
at least one mounting bracket that is configured to couple to the mounting surface of the UAV;
a support bracket; and
at least one damping element extending between the at least one mounting bracket and the support bracket; and
a gimbal coupled to the support structure, the gimbal having a camera mount; and
wherein the attachment supports the camera mount at a position that is forwardly spaced at least 0.1 inches from a forward-most mounting bracket of the at least one mounting bracket.

14. A system comprising:
a UAV having a mounting surface; and
an attachment as in claim 1, wherein the support structure is coupled to the mounting surface of the UAV;
wherein the support structure and the gimbal support the camera relative to the UAV so that the capture line of sight of the sensor of the camera is uninterrupted when pivoted upwardly relative to a horizontal plane by at least 60 degrees and downwardly relative to the horizontal plane by at least 60 degrees.

15. The system of claim 14, wherein the UAV has a center of mass, wherein the attachment supports the camera at a position that is spaced at least 4 inches from the center of mass of the UAV along a longitudinal axis of the attachment.

16. The attachment of claim 1, wherein the support structure comprises:
at least one mounting bracket that is configured to couple to the mounting surface of the UAV;
a support bracket; and
at least one damping element extending between the at least one mounting bracket and the support bracket.

17. The attachment of claim 16, wherein an entirety of the support bracket is isolated from the at least one mounting bracket by the at least one damping element.

18. A method comprising:
attaching, to a mounting surface of a UAV, an attachment comprising:
a support structure;
a gimbal coupled to the support structure; and
a camera supported by the gimbal, the camera having a sensor arranged along a plane, the sensor having a capture line of sight normal to the plane of the sensor;
wherein the support structure and the gimbal support the camera relative to the UAV so that the capture line of sight of the sensor of the camera is uninterrupted when pivoted upwardly relative to a horizontal plane by at least 60 degrees and downwardly relative to the horizontal plane by at least 60 degrees.

19. The method of claim 18, further comprising, prior to attaching the attachment to the mounting surface, removing a first gimbal from a mounting surface of a UAV.

20. The method of claim 18, wherein the gimbal of the attachment is a different type of gimbal than the first gimbal.
